(19) United States
(12) Patent Application Publication
(10) Pub. No.: US 2011/0234989 A1
(43) Pub. Date: Sep. 29, 2011

(54) PROJECTOR

(75) Inventor: Yusuke KUDO, Shiojiri-shi (JP)

(73) Assignee: SEIKO EPSON CORPORATION, TOKYO (JP)

(21) Appl. No.: 13/071,906

(22) Filed: Mar. 25, 2011

(30) Foreign Application Priority Data
Mar. 29, 2010 (JP) 2010-075005

(51) Int. Cl. G03B 21/16

(52) U.S. Cl. 353/52

(57) ABSTRACT

A projector which includes a projection optical device which projects an image includes: a heating unit which heats the projection optical device; and a control unit which controls the heating unit, wherein the control unit controls the heating unit so that the temperature of the projection optical device is equal to or higher than the temperature in which a focal position of the projection optical device is stabilized.

### BACKGROUND

1. Technical Field

The present invention relates to a projector.

2. Related Art

In the related art, there has been known a projector which includes a light source device, a light modulating device which modulates light flux emitted from the light source device to form an image light corresponding to image information, and a projection optical device which enlarges and projects the image light onto a projection target surface such as a screen. Many of these projection optical devices employ a coupling lens in which a plurality of lenses such as a zoom lens and a focusing lens is installed in a lens barrel.

However, in a case where the image is to be displayed clearly on the projection target surface corresponding to the image light emitted from the projection optical device during use of the projector, it is necessary to adjust a focal position of the projection optical device. In this regard, there is known a projector which automatically adjusts the focal position of the projection optical device (refer to JP-A-3-149538, for example).

In the projector (projection type display device) disclosed in JP-A-3-149538, the distance between the projection optical device (projection lens) and the screen is measured using invisible rays and the focal point of the projection optical device is automatically adjusted to an optimal focal position, to thereby achieve operability and accuracy of the focus adjustment.

However, in the projector disclosed in JP-A-3-149538, since the focal position of the projection optical device is adjusted on the basis of the distance between the projector and the screen, it is difficult to correct “out of focus” in the focal position of the projection optical device occurring due to the temperature.

Specifically, when the projector is used, since an image light transmits through a plurality of lenses of the projection optical device, the temperature of the respective lenses is increased. Here, lens characteristics (curvature, refraction index, and the like) may be changed according to the temperature, and distance between lenses may be changed due to the temperature change of the lens barrel. In such a case, the focal position of the entire projection optical device is changed between a low temperature (for example, at the start of use) and a high temperature (for example, after a predetermined time elapses from the start of the use). Thus, the focal position of the projection optical device set on the basis of the above-described distance is changed between the low temperature and the high temperature, and thus, the projection image cannot be displayed clearly. Accordingly, a configuration which can suppress the fluctuation in the focal position of the projection optical device is in demand.

### SUMMARY

An advantage of some aspects of the invention is that it provides a projector which can suppress fluctuation of the focal position of the projection optical device.

According to an aspect of the invention, there is provided a projector which includes a projection optical device which projects an image. The projector includes a heating unit which heats the projection optical device, and a control unit which controls the heating unit. Here, the control unit controls the heating unit so that the temperature of the projection optical device is equal to or higher than the temperature in which a focal position of the projection optical device is stabilized.

Accordingly, the heating unit under the control of the control unit heats the projection optical device so that the temperature of the projection optical device is equal to or higher than the temperature in which the focal position of the projection optical device is stabilized. Thus, as the focal position is adjusted after the temperature of the projection optical device reaches the temperature in which the focal position is stabilized or higher, it is possible to suppress the change in the focal position of the projection optical device before and after adjustment. Accordingly, the image can be displayed clearly.

Here, a configuration in which a cooling unit which cools the projection optical device is installed is considered, in order to suppress the temperature increase of the projection optical device. As such a cooling unit, a fan which blows cooling air may be exemplified. However, in a case where such a fan is installed, since wind noise due to the blowing of the cooling air occurs, silence of the projector is interrupted.

In this respect, for example, if a heater is employed as the heating unit, noise such as wind noise can be suppressed, and silencing of the projector can be obtained compared with a case where the cooling unit is used.

In the projector according to the aspect of the invention, the projection optical device may include a plurality of lens groups. The heating unit may be installed according to the respective lens groups, and the control unit may control the heating unit, respectively.

Here, the “lens group” means one or more lenses having a predetermined function.

According to the aspect of the invention, since the heating unit is installed according to the respective lens groups, it is possible to reliably heat the respective lens groups. Further, it is also possible to individually heat the lens groups according to lens characteristics or the like of the respective lens groups.

### BRIEF DESCRIPTION OF THE DRAWINGS

The invention will be described with reference to the accompanying drawings, wherein like numbers reference like elements.

FIG. 1 is a schematic diagram illustrating a configuration of a projector according to an embodiment of the invention.

FIG. 2 is a schematic diagram illustrating a configuration of a projection optical device and a heating unit according to the embodiment.

FIG. 3 is a diagram illustrating a configuration of a control unit according to the embodiment.

FIG. 4 is a flowchart illustrating a temperature control process performed by a control unit according to the embodiment.

### DESCRIPTION OF EXEMPLARY EMBODIMENTS

Hereinafter, embodiments of the invention will be described with reference to the accompanying drawings.

### Configuration of Projector

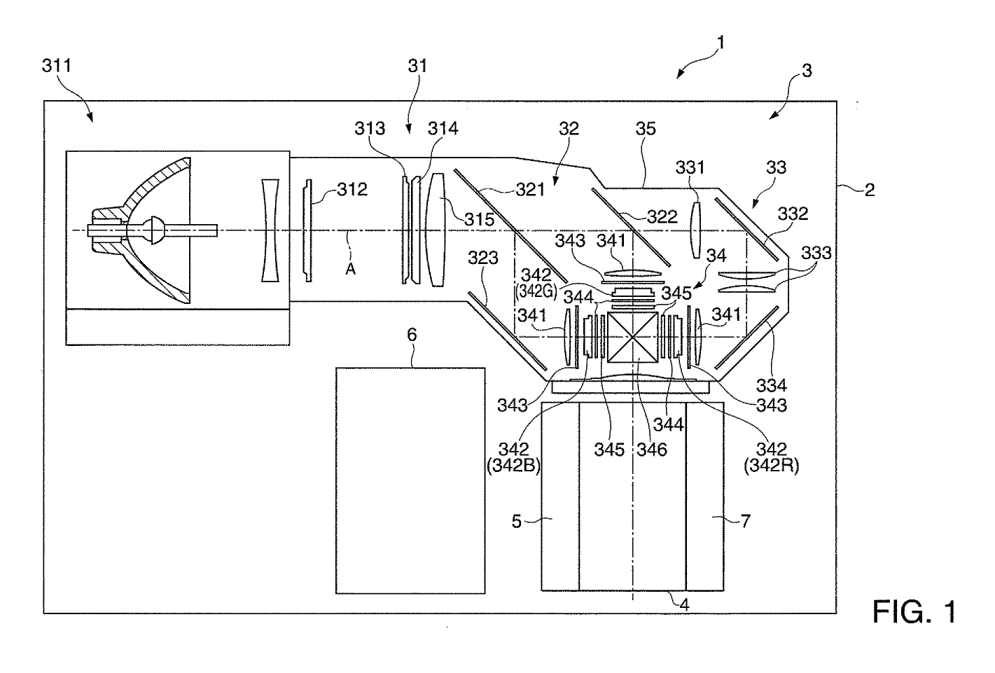

FIG. 1 is a schematic diagram illustrating a configuration of a projector 1 according to an embodiment of the invention.

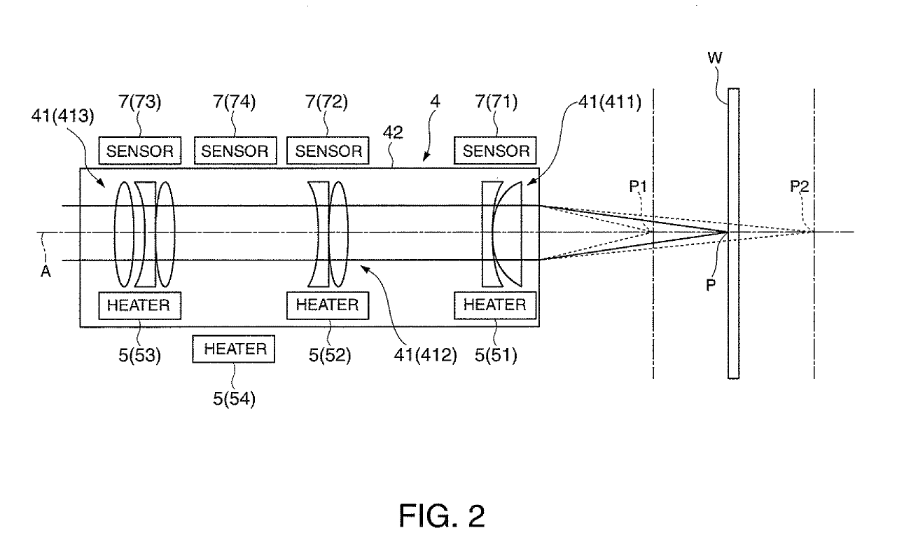

The projector 1 according to this embodiment modulates a light flux emitted from a light source device 311 which is installed therein, forms an image according to image information, and enlarges and projects the image onto a projection target surface W (see FIG. 2) such as a screen. As shown in FIG. 1, the projector 1 includes an external housing 2, an image forming device 3, a projection optical device 4, a heating unit 5, a control unit 6, and a temperature sensor 7.

Among them, the external housing 2 is formed in an approximately rectangular parallelepiped shape of synthetic resin or metal, and accommodates and arranges the above described respective devices 3 and 4, the respective units 5 and 6, and the like therein.

### Configuration of Image Forming Device

The image forming device 3 is an optical device which forms image light corresponding to image information under the control of the control unit 6. The image forming device 3 includes an illumination optical device 31, a color splitting optical device 32, a relay optical device 33, an electro-optical device 34, and an optical component housing which accommodates and arranges these devices in predetermined positions on an illumination optical axis A which is set therein and supports the projection optical device 4 which will be described later.

The illumination optical device 31 includes a light source device 311, a pair of lens arrays 312 and 313, a polarization converting element 314, and a superposed lens 315.

The color splitting optical device 32 includes dichroic mirrors 321 and 322 and a reflection mirror 323, and the relay optical device 33 includes an incident lens 331, a relay lens 333, and reflection mirrors 332 and 334.

The electro-optical device 34 includes a field lens 341, three liquid crystal panels 342 (liquid crystal panels for red, green, and blue are respectively represented as 342R, 342G, and 342B) which are light modulation devices, three plates respectively of an incident polarization plate 343, a view angle compensation plate 344, and an emission polarization plate 345, and a cross dichroic prism 346 which is a color composition optical device.

In such an image forming device 3, the light flux in which the illuminance in an illumination region is approximately uniformized is emitted by the illumination optical device 31, and the light flux is split into three color lights of R, G, and B by the color splitting optical device 32. The split respective color lights are modulated according to the image information by the respective liquid crystal panels 342 to form images for the respective color lights. Further, the images for the respective color lights are composed by the cross dichroic prism 346, and are enlarged and projected onto the projection target surface W (see FIG. 2) by the projection optical device 4.

### Configuration of Projection Optical Device

FIG. 2 is a schematic diagram illustrating a configuration of the projection optical device 4 and the heating unit 5.

The projection optical device 4 forms an image formed by the image forming device 3 on the projection target surface W, and enlarges and projects the image. As shown in FIG. 2, the projection optical device 4 is configured as a coupling lens including three lens groups 41 (first lens group 411, second lens group 412, and third lens group 413 from the side closest to the projection target surface W) and a lens barrel 42 which accommodates the respective lens groups 41 therein. Here, the “lens group” means one or more lenses having a predetermined function.

### Configuration of Heating Unit

The heating unit 5 corresponds to the heating unit as one component in the embodiment of the invention, and is for heating the lens groups 41 and for heating the projection optical device 4. The heating unit 5 includes a heater 51 which heats the first lens group 411, a heater 52 which heats the second lens group 412, a heater 53 which heats the third lens group 413, and a heater 54 which heats the lens barrel 42. As long as these heaters 51 to 54 can heat all the lenses of the respective lens groups 41 and the lens barrel 42 at a uniform temperature, the configurations thereof are not particularly limited. Specifically, the heaters 51 to 53 may be configured to cover peripheries of the respective lens groups 41 with an electrically-heated wire, and the heater 54 may be configured to cover an outer surface of the lens barrel 42 with an electric heating wire.

### Configuration of Temperature Sensor

The temperature sensor 7 is a detecting unit which detects the temperature around the projection optical device 4 under the control of the control unit 6 which will be described later. The temperature sensor 7 includes a first sensor 71, a second sensor 72, and a third sensor 73 which respectively detect the temperature around the first lens group 411, the second lens group 412, and the third lens group 413, and a fourth sensor 74 which detects the temperature of the lens barrel 42.

### Configuration of Control Unit

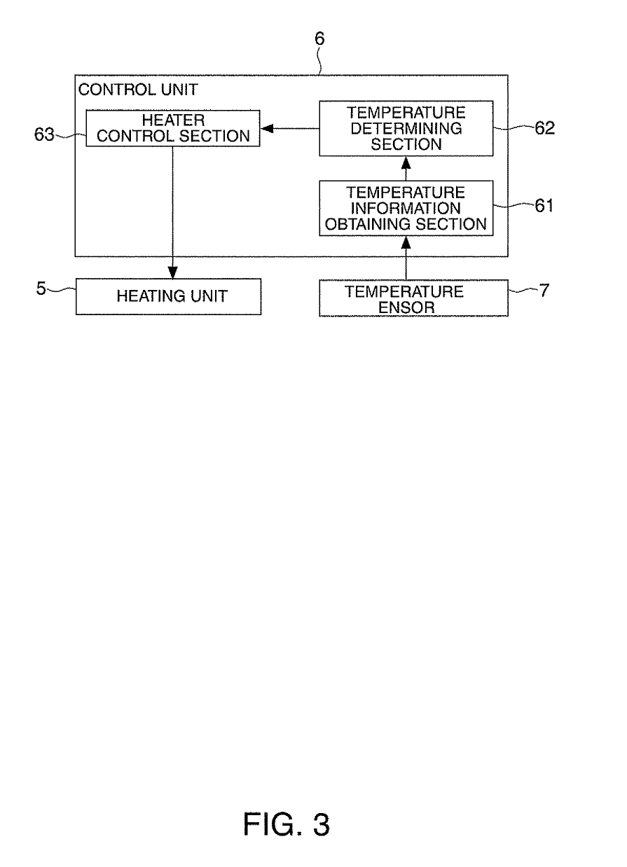

FIG. 3 is a diagram illustrating a configuration of the control unit 6.

The control unit 6 corresponds to the control unit as one component in the embodiment of the invention, and autonomously controls the entire operations of the projector 1 or by manipulation of a user. For example, the control unit 6 controls a heating state through the above-described heaters 51 to 54. Thus, as shown in FIG. 3, the control unit 6 includes a temperature information obtaining section 61, a temperature determining section 62, and a heater control section 63. Further, the control unit 6 performs a temperature control process which will be described hereinafter by these sections.

The temperature information obtaining section 61 obtains the temperature around the projection optical device 4 detected by the temperature sensor 7.

The temperature determining section 62 determines whether the temperature (obtained temperature) obtained by the temperature information obtaining section 61 is equal to or higher than a stabilized temperature which is stored in advance as the temperature detected by the temperature sensor 7 when a focal position of the projection optical device 4 is stabilized.

In a case where it is determined that the obtained temperature is lower than the stabilized temperature by the temperature determining section 62, the heater control section 63 heats the respective lens groups 41 to 43 and the lens barrel 42 by the above-described heaters 51 to 54. Further, in a case where the obtained temperature is equal to or higher than the stabilized temperature, the heater control section 63 stops the heating by the heaters 51 to 54.

### Temperature Control Process

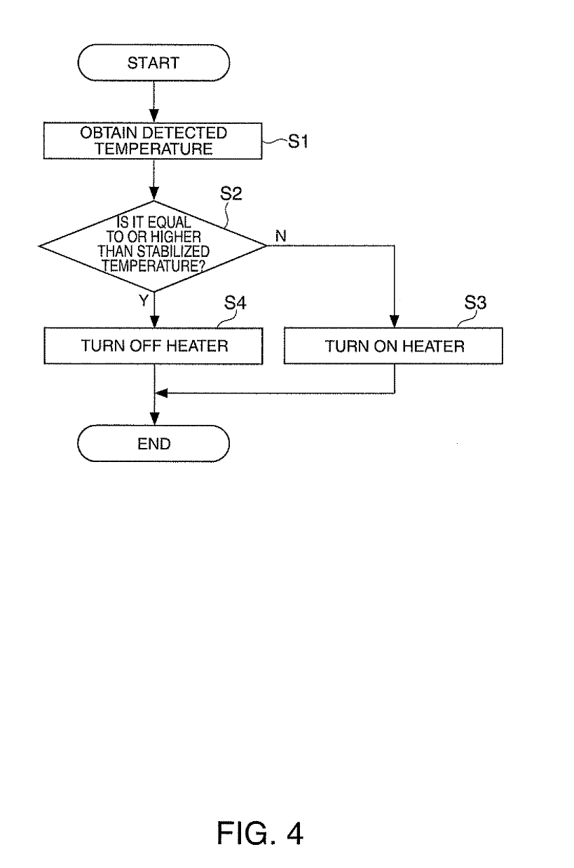

FIG. 4 is a flowchart illustrating a temperature control process performed by the control unit 6.

If electric power of the projector 1 is supplied, the above-described control unit 6 performs the following temperature control process to maintain the temperature of the projection optical device 4 at an approximately constant level, to thereby suppress a fluctuation in the focal position of the projection optical device 4. This temperature control process is performed according to a temperature control program stored in a storage section (not shown).

In this temperature control process, as shown in FIG. 4, firstly, the temperature information obtaining section 61 obtains the temperature detected by the temperature sensor 7 (step S1).

Next, the temperature determining section 62 compares the obtained temperature and the above-described stabilized temperature and determines whether the obtained temperature is equal to or higher than the stabilized temperature (step S2).

Here, if it is determined that the obtained temperature is lower than the stabilized temperature, the heater control section 63 turns on the heaters 51 to 54 to heat the lens groups 41 and the lens barrel 42 (step S3).

On the other hand, if it is determined that the obtained temperature is equal to or higher than the stabilized temperature, the heater control section 63 turns off the heaters 51 to 54 to stop the heating of the lens groups 41 and the lens barrel 42 (step S4).

Further, as these steps S1 to S4 are repeatedly performed, the entire projection optical device 4 having the respective lens groups 41 and the lens barrel 42 is controlled at a predetermined temperature.

When it is first determined that the obtained temperature is equal to or higher than the stabilized temperature after the electric power of the projector 1 is supplied, it is possible to display a notification that a focus adjustment is possible on the projection screen or the manipulation panel or to automatically perform the focal position adjustment.

### Focal Position of Projection Optical Device

The focal position of the projection optical device 4 is fluctuated according to lens characteristics and inter-lens distances of the respective lens groups 411 to 413 which are changed according to the temperature.

Specifically, as shown in FIG. 2, if the temperature change occurs in the projection optical device 4, the focal position of the projection optical device 4 is fluctuated in a direction (position P1) close to the projection optical device 4 or a direction (position P2) away from the projection optical device 4, along the illumination light axis A from a focal position P at a low temperature, as indicated by dashed lines. In such a case, so-called “out of focus” occurs in the projected image.

In regard to this, in this embodiment, as the projection optical device 4 is maintained at the stabilized temperature, it is possible to suppress the change in the focal position before and after the adjustment of the focal position of the projection optical device 4, without change in the lens position or the like.

The above-described projector 1 according to this embodiment has the following effects.

The heating unit 5 heats the projection optical device 4 under the control of the control unit 6 so that the temperature of the projection optical device 4 is equal to or higher than the temperature in which the focal position of the projection optical device 4 is stabilized. Accordingly, as the focal position is adjusted after the temperature of the projection optical device 4 reaches the temperature in which the focal position is stabilized or higher, it is possible to suppress the change in the focal position of the projection optical device 4 before and after the adjustment. Accordingly, the image can be displayed clearly.

Further, as the heater 51 to 54 are used as the heating unit 5, noise such as wind noise can be suppressed, and silencing of the projector 1 can be obtained compared with a case where a cooling unit is used.

Furthermore, since the heaters 51 to 53 are installed according to the respective lens groups 411 to 413, it is possible to reliably heat the respective lens groups 411 to 413. Further, according to the lens characteristics of the respective lens groups 411 to 413, it is possible to individually heat the lens groups 411 to 413.

### Modifications

The invention is not limited to the above-described embodiment, and a variety of modifications and improvements may be made in a range without departing from the spirit of the invention.

In the above-described embodiment, the temperature sensor 7 includes three sensors 71 to 73, but the invention is not limited thereto. For example, the temperature sensor 7 may include a single sensor which detects the temperature of the entire projection optical device 4 or the temperature around the projection optical device 4.

In the above-described embodiment, as the temperature of the projection optical device 4, the temperature around the respective lens groups 41 and the temperature of the lens barrel 42 are detected, but the invention is not limited thereto. For example, the temperature sensor 7 may be installed in the lens barrel 42 to directly detect the temperatures of the respective lens groups 41. Further, the temperature around the projection optical device 4 may be detected, and then the temperature of the entire projection optical device 4 may be estimated from the detected temperature.

In the above-described embodiment, the heaters 51 to 53 are installed in the lens barrel 42 and the heater 54 is installed outside the lens barrel 42, but the invention is not limited thereto. For example, as long as the heaters 51 to 54 can heat the corresponding respective lens groups 41 and the lens barrel 42, the installation locations of the heaters 51 to 54 may be inside or outside of the lens barrel 42.

In the above-described embodiment, the heaters 51 to 53 which heat the respective lens groups 411 to 413 are installed for the respective lens groups 411 to 413, but the invention is not limited thereto. That is, the heater may be installed to heat only the lens group which causes the fluctuation in the focal position by the temperature change.

In the above-described embodiment, the projector includes the projection optical device having three lens groups 41 (411 to 413), but the invention is not limited thereto. That is, the number of the lens groups included in the projection optical device may be appropriately set on the basis of characteristics, performance, manufacturing cost, or the like of the projection optical device.

In the above-described embodiment, the projector uses three light modulation devices, but the invention is not limited thereto. For example, the projector may use only one light modulation device, two light modulation devices, or four or more light modulation devices. Further, the liquid crystal panel is used as the light modulation device, but the invention is not limited thereto. For example, a light modulation device other than the liquid crystal, such as a device which uses a micro mirror, may be employed. Further, a reflective light modulation device may be used, instead of a transmissive light modulation device.

In the above-described embodiment, the projector 1 is configured as a front type projector in which a projection direction of an image on the projection target surface and an observation direction of the image are approximately the same, but the invention is not limited thereto. For example, a rear type projector in which the projection direction and the observation direction are opposite to each other may be employed.

Accordingly, the invention can be applied to a projector which includes the projection optical device which projects the formed image.

The entire disclosure of Japanese Patent Application No. 2010-075005, filed Mar. 29, 2010 is expressly incorporated by reference herein

What is claimed is:

1. A projector comprising:
a projection optical device that projects an image;
a heating unit that heats the projection optical device; and
a control unit that controls the heating unit,
the control unit controlling the heating unit so that the temperature of the projection optical device is equal to or higher than the temperature in which a focal position of the projection optical device is stabilized.

2. The projector according to claim 1,
wherein the projection optical device includes a plurality of lens groups,
wherein the heating unit is installed according to the respective lens groups, and
wherein the control unit controls the heating unit, respectively.

3. The projector according to claim 1,
wherein the projection optical device includes lens and a lens barrel that accommodates the lens therein,
wherein the heating unit includes a heater that heats the lens barrel.

4. The projector according to claim 2,
wherein the projection optical device includes a lens barrel that accommodates the respective lens groups therein,
wherein the heating unit includes a heater that heats the lens barrel.
